(19) United States
(12) Patent Application Publication
(10) Pub. No.: US 2023/0151225 A1
(43) Pub. Date: May 18, 2023

(54) BLENDING ZINC PYRITHIONE WITH BASE MATERIALS IN ORDER TO CREATE QUICKLY APPLIED ANTI-MICROBIAL SURFACES

(71) Applicant: CAO Group, Inc., West Jordan, UT (US)

(72) Inventors: Steven D Jensen, South Jordan, UT (US); Densen CAO, Sandy, UT (US)

(73) Assignee: CAO GROUP, INC., West Jordan, UT (US)

(21) Appl. No.: 17/916,380

(22) PCT Filed: Mar. 30, 2021
(86) PCT No.: PCT/US2021/025012

§ 371 Date: Sep. 30, 2022

Related U.S. Application Data
(60) Provisional application No. 63/002,912, filed on Mar. 31, 2020.

(51) Int. Cl. C09D 5/14; A01N 59/16; A01N 25/10; A01N 25/34; C09D 123/06; C09D 7/61; C09D 7/80

(52) U.S. Cl. CPC C09D 5/14; A01N 59/16; A01N 25/10; A01N 25/34; C09D 123/06; C09D 7/61; C09D 7/80

(57) ABSTRACT

Films and sheets of material with improved anti-microbial properties inherent in the material itself may feature zinc pyrithione or another water insoluble salt of pyrithione incorporated homogeneously into the base substance of the material. Such material may be formed into any barrier films (100) or sheets such that they are imbued with the zinc pyrithione (110) throughout at least one component of the final product, if not the whole volume of the finished product. Additional layers, such as adhesive layer (130) and barrier layer (120), may be added dependent upon the desired final product construction. Sheets or films may or may not be pre-formed to fit given surfaces.

### CROSS-REFERENCES TO RELATED APPLICATIONS

This application claims priority to prior filed U.S. Application No. 63/002,912, filed Mar. 31, 2020, and incorporates the same by reference herein in its entirety.

### FIELD OF THE INVENTION

The present invention relates to the field of construction and more particularly relates to construction materials which have been treated with an anti-microbial agent.

### BACKGROUND OF THE INVENTION

There is a need, especially in the medical, dental, food service, hospitality, transportation, and many other industries to control microbial activity and growth on common surfaces, like handles, tables, and countertops, or common tools and interfaces, like mice, pointers, touchscreens, and keypads. There are many high traffic areas that are susceptible to contamination with microbes daily, many of these areas become heavily contaminated and are not cleaned or disinfected appropriately such that they become havens for microbial biofilms that spread disease. In addition to using surface disinfectant, there are other temporary solutions to this problem by utilizing anti-microbial agents in coating materials such as paint or dye. Nevertheless, these coatings present a problem for areas that must be cleaned often with a towel and cleansers because they will eventually chip and flake leaving areas that have gaps and fissures (210) that become collecting points for microbial contamination (300) (FIG. 8). Unfortunately, the only way to address the issue of such chips and cracks is to immediately re-treat the surface, which realistically does not happen until the entire surface needs to be repainted. Temporary anti-microbial paints are better suited on exterior housing where they can weather unmolested until such a time that they require another coat of paint. There are also many surfaces which are not well suited to treatment with paint, so such cracks, chips, and fissures must remain until the entire surface is replaced.

Many anti-microbial agents exist. Of these, the salts of pyrithione, especially zinc pyrithione, show great promise in the potential to provide continuous anti-microbial protection. Zinc pyrithione has been utilized to combat microbial contamination of surfaces. However, its use is generally limited to being mixed with paint (for durable surfaces) or a dye/wash (for textiles). In these cases, the protection of zinc pyrithione is lost if the paint chips or it is washed away. Some materials, such as cement or caulk, have zinc pyrithione mixed into them in a slurry state and are then cured into a final form. Polymers have been soaked in a solution of zinc pyrithione to imbue anti-microbial characteristics, but this soaking typically takes an exceptional amount of time and occurs after the polymer is fashioned into its final form.

The present invention is directed towards adhesive film and sheet materials for surfaces wherein the anti-microbial agent is imbedded permanently within the materials themselves during manufacture. The present invention represents a departure from the prior art in that the method and materials of the present invention allows for surfaces to be easily treated in an inexpensive and less inconvenient manner and quickly acquire anti-microbial properties and to easily maintain such properties by simply replacing a worn or damaged film or protective sheet over the surface.

### SUMMARY OF THE INVENTION

In view of the foregoing disadvantages inherent in the known types of anti-microbial coatings, an improved anti-microbial material may provide a surface treatment that meets the following objectives: that it is easily applied to a surface desired to be treated, that it is easily and inexpensively manufactured, that it is effective in retarding the growth of microbial colonies on its surface, and that it may be incorporated into existing surfaces in household, commercial, and industrial use, including covering electronics, commonly touched surfaces, and building construction or renovation materials. As such, a new and improved anti-microbial material may comprise anti-microbial agents such as water insoluble salts of pyrithione to accomplish these objectives. Water insoluble salts of pyrithione, especially zinc pyrithione, when blended with many common materials provides long-term anti-microbial surfaces for a multitude of hard, soft, and elastomeric materials. The water-soluble salts of pyrithione such as sodium or potassium salts are not within the scope of the invention as they will eventually dissolve and wash out of the treated material and are therefore not permanent, by which is meant that the material will structurally fail and need to be replaced before the anti-microbial activity of the material decreases to an ineffective level.

The present invention creates surfaces that are anti-microbial over the structural useful life of the film or sheet and are designed to be fabricated and utilized on the surfaces which people contact as they go about day-to-day life. The present invention creates surfaces that are much more forgiving to all forms of contamination, especially in inhibiting the formation of biofilms. In the medical, dental and food service industries these high traffic areas are common and are often contaminated with human biological fluids along with various foreign sources of contamination. Many contaminants are invisible to the naked eye and therefore provide no clue that a surface is compromised. Therefore, there is a great need for an easily applied and more permanent form of anti-microbial activity, especially when these areas are not cleaned and disinfected as required. The present invention provides constant anti-microbial activity, even when the contamination is unseen, and provides easy replacement and reapplication of an anti-microbial shield to such surfaces when structural failure of the shield does happen.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a roll of polymer film imbued with zinc pyrithione additive.

FIG. 2 is a close-up view of the polymer film of FIG. 1, taken in circle II.

FIG. 3 is a schematic view of a door with an untreated push plate.

FIG. 4 is a close-up view of the door of FIG. 3, taken in circle IV.

FIG. 5 is a schematic view of the door of FIG. 3 but having its push plate treated with the film of FIG. 1.

FIG. 6 is a close-up view of the door of FIG. 5, taken in circle VI.

FIG. 7 is a perspective view of a sheet of material made according to one embodiment of the present invention.

FIG. 8 is a perspective view showing prior art protection by paint.

### DETAILED DESCRIPTION OF THE PREFERRED EMBODIMENT

With reference now to the drawings, a preferred embodiment of the method of manufacturing anti-microbial building materials is herein described. It should be noted that the articles “a”, “an”, and “the”, as used in this specification, include plural referents unless the content clearly dictates otherwise.

The preferred anti-microbial of the present invention is zinc pyrithione as its solubility in water is only 8 ppm and is one of the best biocompatible long-term anti-microbial agents known. It is a broad spectrum anti-microbial effective against a wide range of microorganisms such as bacteria, fungi, yeast, molds, viruses, spores, and many other organisms. Zinc pyrithione is especially useful as it has excellent anti-microbial activity even at very low concentrations. Other salts of pyrithione, such as copper pyrithione, are also useful, but are not as preferred.

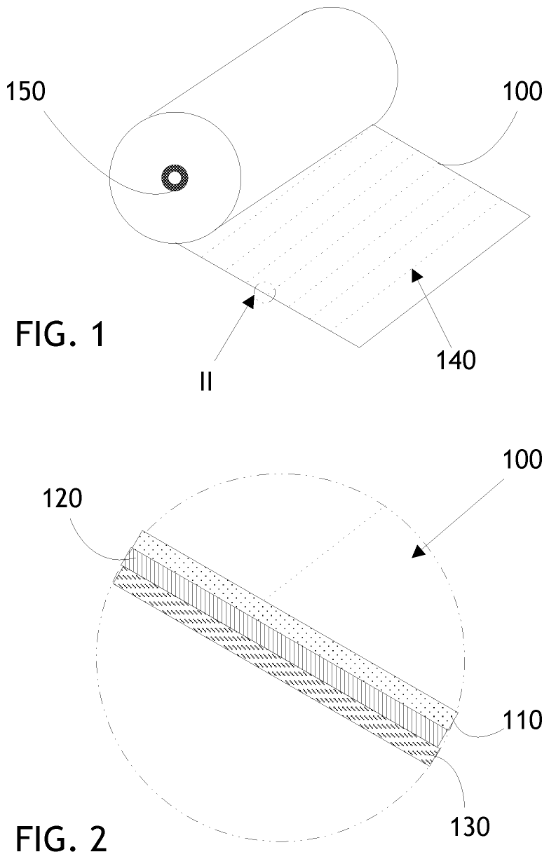

The preferred concentration of zinc pyrithione to be blended within the base film material is 0.01%-30% by weight. The film material may be any polymer or other material from which a film may be made. The concentration will vary by the base material as the addition of zinc pyrithione will affect the overall physical properties and these will need be adjusted to balance the anti-microbial activity without adversely altering the physical or chemical properties. In the preferred embodiment, polyethylene is the base material and the concentration of zinc pyrithione to polyethylene is 5% by weight. As shown in FIG. 1, the film (100) may be rolled (150) or be distributed in sheets, and the film may be perforated (140) for easy tearing. The ideal embodiment, shown in FIG. 2, utilizes three distinct layers, an active layer (110), a barrier layer (120), and an adhesive layer (130). The active layer (110) contains the material/zinc pyrithione blend. The adhesive layer (130) is used to attach the film to a desired surface and the barrier layer (120) separates the other layers to prevent interaction and provide additional body to the film (100). The film (100) may utilize as many barrier layers (120) as necessary to achieve a desired effect, including no barrier layers. The film may also utilize a single active layer (110) and forego an adhesive layer (130), relying on any inherent tackiness of the material for adhesion to a surface. In other embodiments, a separate adhesive may be utilized. The layers may be three separate materials or may be the same base material. In the preferred embodiment, all three layers are polyethylene, however only the active layer (110) is blended with zinc pyrithione. The preferred embodiment relies on the inherent tackiness of the polyethylene to adhere to a surface.

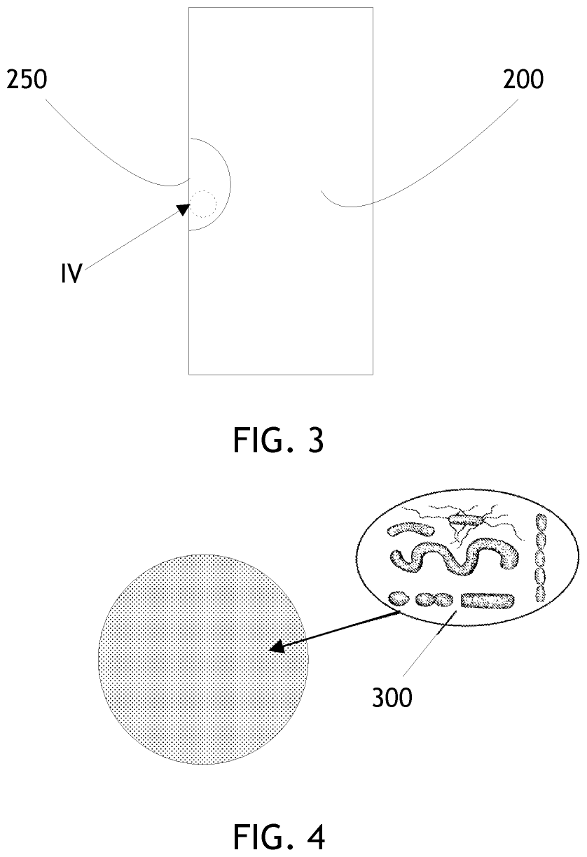

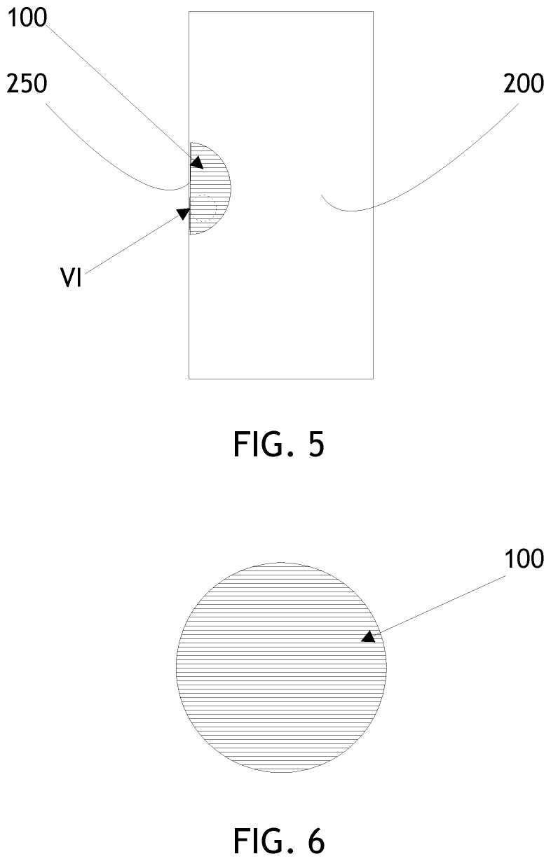

The present invention may be used on any high-contact surface, such as the door push plate in FIGS. 3-6. As shown in FIG. 3, an interior door (200) may be unlatched for it to swing freely as it is pushed or pulled. Such a door (200) usually has a push plate (250) that is frequently touched and can become a breeding ground for microbe colonies (300), FIG. 4. Simply placing a sheet of the antimicrobial film (100) on the door push plate (250), as shown in FIG. 5, can drastically reduce the incidence of microbial growth on the surface (FIG. 6). Likewise, any other suitable surface may be treated with the anti-microbial film (100). The use of a film allows us in places where tactile response is needed, such as keypads or touchscreens, as the film (100) will not interfere with the operation of the treated surface or interface. Films are also easily replaceable if they become damaged or torn.

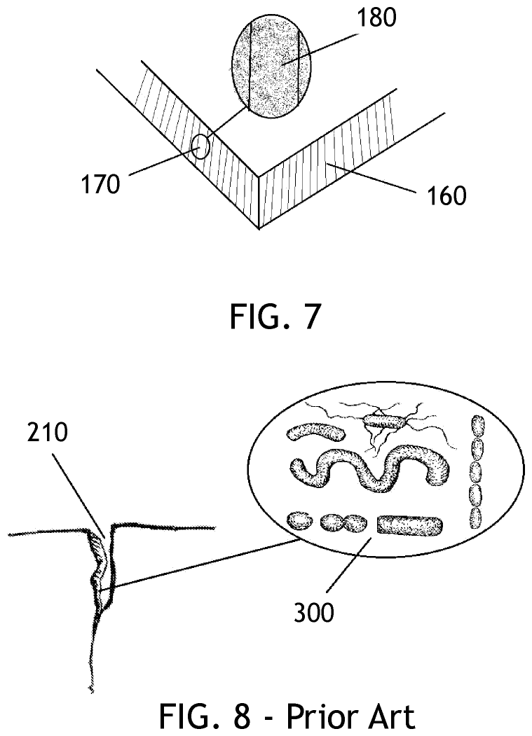

While the preferred embodiment of the invention is for films, an embodiment of the present invention blends zinc pyrithione with an elastomer to form a sheet (160), FIG. 7. that is then pre-shaped to be placed over a door handle or the handle of a gasoline or diesel fuel pump dispenser. As with the films, zinc pyrithione is added to an elastomer of choice and blended such that a sample (170) of the active layer would contain a homogenous blend of zinc pyrithione (180) throughout the active layer. For purposes of this Specification, the difference between a “film” and a “sheet” is essentially one of thickness. A film typically has a maximum thickness of 25-26 μm, or a mil ( 1/1000 inch) while a sheet can be of any thickness so long as the length and width of the sheet are vastly larger. Either could be permanently molded into a particular form, however sheets will generally have greater ability to withstand the process and generally have greater ability to maintain the final form. Sheets may be more effectively manufactured as a single layer, as is depicted in FIG. 7, with an optional adhesive added to affix the sheet onto a desired surface.

While added coverings such as those described here could conceivably be more readily damaged and limit anti-microbial protection, these coverings are far more durable than prior art paints and infusions and present anti-microbial protection integrally throughout their construction.

Commonly touched surfaces, such as counters, table-tops, doors, keypads, fuel pumps, etc. are the most preferred uses for the material. It should be readily understood that other durable construction materials would benefit and could be manufactured in similar manner to what is described herein. An embodiment of the present invention blends zinc pyrithione into inorganic materials such as compressed stone, and laminates. Zinc pyrithione is blended directly with these inorganic materials prior to being fabricated into a permanent state and shaped. Wood and adhesives may also be treated with zinc pyrithione and made into pressed wood products.

An embodiment of the present invention blends or mixes zinc pyrithione within polymeric construction materials until the zinc pyrithione is in a homogenous blend with the material. Zinc pyrithione can be blended directly with thermoplastic or thermoset plastics while in the molten state until homogeneous and then allowed to cool into a solid permanent state. Plastics, polymers, and elastomers provide a preferred construction material as they can be molded into virtually any size or shape, including films, while offering a very diverse range of physical properties and surfaces. Zinc pyrithione can be blended with polymers or resins that require a chemical cure to set into solid form. Zinc pyrithione can be pre-blended into one or more of the separate components and sold as such time the consumer mixes the multi-component system to produce a permanent form when desired.

Although the present invention has been described with reference to preferred embodiments, numerous modifications and variations can be made and still the result will come within the scope of the invention. No limitation with respect to the specific embodiments disclosed herein is intended or should be inferred.

### INDUSTRIAL APPLICABILITY

The present invention has industrial applicability as it may be manufactured by industry and has particular relevance for use in the microbial amelioration industry.

1. An anti-microbial surface treatment comprising:
a polyethylene base material; and
a salt of pyrithione, such that the a salt of pyrithione and polyethylene base material are blended until homogeneity is achieved and the combination is thereafter processed into a final state;
wherein the final state of the surface treatment is a film with at least one layer thereof being formed from the homogenous blend of the polyethylene base material and the a salt of pyrithione, and no adhesive layers.

2. The anti-microbial surface treatment of claim 1, the anti-microbial agent being a water insoluble salt of pyrithione.

3. The anti-microbial surface treatment of claim 1, the water insoluble salt of pyrithione being zinc pyrithione.

4. The anti-microbial surface treatment of claim 3, the base material being a polymer.

5. The anti-microbial surface treatment of claim 3, the base material being polyethylene.

6. The anti-microbial surface treatment of claim 3, the concentration of zinc pyrithione being between 0.01% and 30% of the total weight of the anti-microbial surface treatment.

7. The anti-microbial surface treatment of claim 3, the concentration of zinc pyrithione being 5% of the total weight of the anti-microbial surface treatment.

8. The anti-microbial surface treatment of claim 2, the film further comprising an active layer, made from the blended base material and the salt of pyrithione, a barrier layer adjacent thereto, and an adhesive layer.

9. The anti-microbial surface treatment of claim 8, the water insoluble salt of pyrithione being zinc pyrithione.

10. The anti-microbial surface treatment of claim 9, the base material being a polymer.

11. The anti-microbial surface treatment of claim 9, the base material being polyethylene.

12. An anti-microbial surface treatment comprising:
a polyethylene base material; and
a salt of pyrithione such that the salt of pyrithione and polyethylene base material are blended until homogeneity is achieved and the combination is thereafter processed into a final state;
wherein the final state of the surface treatment is a sheet with at least one layer thereof being formed from the homogenous blend of the polyethylene base material and the salt of pyrithione and no adhesive layers between.

13. The anti-microbial surface treatment of claim 12, the anti-microbial agent being a water insoluble salt of pyrithione.

14. The anti-microbial surface treatment of claim 12, the water insoluble salt of pyrithione being zinc pyrithione.

15. The anti-microbial surface treatment of claim 14, the base material being a polymer.

16. The anti-microbial surface treatment of claim 14, the concentration of zinc pyrithione being between 0.01% and 30% of the total weight of the anti-microbial surface treatment.

17. The anti-microbial surface treatment of claim 14, the concentration of zinc pyrithione being 5% of the total weight of the anti-microbial surface treatment.

18. The anti-microbial surface treatment of claim 13, the sheet further comprising an active layer, made from the blended base material and salt of pyrithione, a barrier layer adjacent thereto, and an adhesive layer.

19. The anti-microbial surface treatment of claim 18, the water insoluble salt of pyrithione being zinc pyrithione.

20. The anti-microbial surface treatment of claim 19, the base material being a polymer.
